(19) United States
(12) Patent Application Publication
(10) Pub. No.: US 2016/0247282 A1
(43) Pub. Date: Aug. 25, 2016

(54) ACTIVE SURFACE PROJECTION CORRECTION

(71) Applicant: Brian Mullins, Sierra Madre, CA (US)

(72) Inventor: Brian Mullins, Sierra Madre, CA (US)

(73) Assignee: DAQRI, LLC, Los Angeles, CA (US)

(21) Appl. No.: 15/047,172

(22) Filed: Feb. 18, 2016

Related U.S. Application Data
(60) Provisional application No. 62/118,360, filed on Feb. 19, 2015.

(51) Int. Cl. G06T 7/00; G02B 27/01

(52) U.S. Cl. CPC G06T 7/0042; G02B 27/0172; G06T 2207/30204; G02B 2027/014

(57) ABSTRACT

Techniques of active surface projection correction are disclosed. In some embodiments, a computer-implemented method comprises determining that a current position of a display surface of a head-mounted display device is determined to satisfy a predetermined condition for displaying virtual content on the display surface, with the display surface being configured to be adjusted between positions that do not satisfy the predetermined condition and positions that do satisfy the predetermined condition, determining display surface position data based on the current position of the display surface, determining a display location for the virtual content based on the display surface position data, and displaying the virtual content at the display location on the display surface.

### CROSS-REFERENCE TO RELATED APPLICATIONS

This application claims the benefit of U.S. Provisional Application No. 62/118,360, filed Feb. 19, 2015, which is hereby incorporated by reference in its entirety.

### TECHNICAL FIELD

The present application relates generally to the technical field of data processing, and, in various embodiments, to methods and systems of active surface projection correction.

### BACKGROUND

Head-mounted display (HMD) devices allow users to observe a scene while simultaneously seeing relevant virtual content that may be aligned (beneficially) to item, images, objects, or environments in the field of view of the device or user. However, existing HMD devices do not account for the change in relative positioning of the display surface with respect to the other components (e.g., a projector) of the HMD device, that occurs over time due to the use of the HMD, as well as other factors, such as environmental changes (e.g., temperature, humidity).

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating components of an HMD device, in accordance with some embodiments;

FIG. 2 is a block diagram illustrating components of a virtual content module, in accordance with some embodiments;

FIG. 3 is a plan view of an HMD device, in accordance with some embodiments;

FIGS. 4A-4C illustrates a display surface of an HMD device in different positions, in accordance with some embodiments;

FIG. 5 is a flowchart illustrating a method of correcting a display of virtual content on an HMD device, in accordance with some embodiments;

FIG. 6 is a block diagram of an example computer system on which methodologies described herein may be executed, in accordance with some embodiments; and

FIG. 7 is a block diagram illustrating a mobile device, in accordance with some embodiments.

### DETAILED DESCRIPTION

Example methods and systems of active surface projection correction are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure provides techniques for adjusting the display location of virtual content on a display surface based on a detected shift in a display-ready position of the display surface. In some embodiments, a computer-implemented method comprises determining that a current position of a display surface of a head-mounted display device satisfies a predetermined condition for displaying virtual content on the display surface, with the display surface being configured to be adjusted between one or more positions that do not satisfy the predetermined condition and one or more positions that do satisfy the predetermined condition, determining display surface position data based on the current position of the display surface, determining a display location for the virtual content based on the display surface position data, and displaying the virtual content at the display location on the display surface. In some example embodiments, the operation of determining the display surface position data is performed in response to the determining that the current position of the display surface satisfies the predetermined condition.

In some example embodiments, the determining the display surface position data comprises determining the display surface position data based on a detection of a position marker using at least one sensor, the position marker being coupled to the display surface in a fixed position with respect to the display surface, and adjustment of the display surface between positions is accompanied by corresponding adjustment of the position marker between positions.

In some example embodiments, the determining the display location for the virtual content based on the display surface position data comprises using the display surface position data as an offset value to apply to a previously-determined display location on the display surface in compensating for a change in position of the display surface since a display of previous virtual content on the display surface at a previous time.

In some example embodiments, the determining the display location for the virtual content is further based on at least one of an ambient temperature of the display surface and an ambient humidity level of the display surface.

In some example embodiments, the determining the display surface position data is performed in response to the determining that the current position of the display surface satisfies the predetermined condition.

In some example embodiments, determining that the current position of the display surface of the head-mounted display device satisfies the predetermined condition comprises determining that the display surface is releasably locked in a display mode position via a locking mechanism.

In some example embodiments, determining that the current position of the display surface of the head-mounted display device satisfies the predetermined condition comprises detecting that a position marker of the display surface is in a position corresponding to the current position of the display surface satisfying the predetermined condition, the position marker being coupled to the display surface in a fixed position with respect to the display surface, and adjustment of the display surface between positions is accompanied by corresponding adjustment of the position marker between positions.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

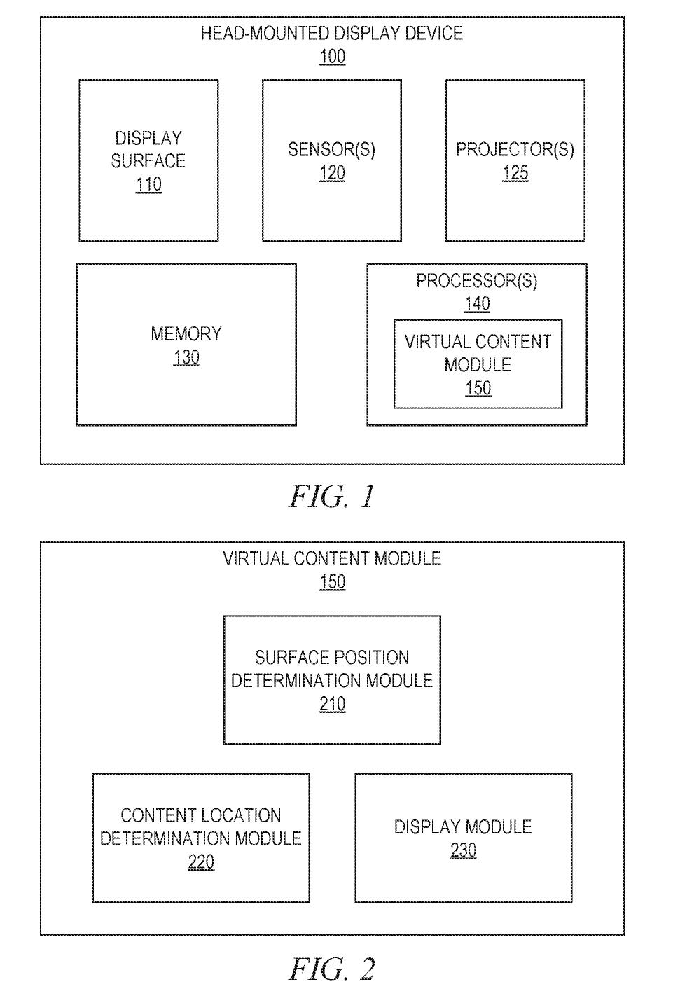

FIG. 1 is a block diagram illustrating a head-mounted display (HMD) device 100, in accordance with some embodiments. HMD device 100 may comprise any computing device that is configured to be worn on the head of a user or as part of a helmet, and that comprises a display surface 110 on which virtual content (e.g., images) can be displayed. In some embodiments, the HMD device comprises an optical HMD device, which may include, but is not limited to, a helmet-mounted display device, glasses (e.g., Google Glass®), or other temporary or permanent form factors that can be either binocular or monocular. However, it is contemplated that other types of HMD devices 100 are also within the scope of the present disclosure. In some embodiments, HMD device 100 also comprises one or more sensors 120, one or more projectors 125, memory 130, and one or more processors 140.

In some example embodiments, the display surface 110 is transparent or semi-opaque so that the user of the computing device 100 can see through the display surface 110 to the visual content in the real-world environment, while virtual content is displayed on the display surface 110. The HMD device 100 is configured to present the virtual content to the user without requiring the user to look away from his or her usual viewpoint, such as with the user's head positioned up and looking forward, instead of angled down to look at a device.

In some embodiments, the sensor(s) 120 comprises a built-in camera or camcorder with which a user of the HMD device 100 can use to capture image data of visual content in a real-world environment (e.g., image data of a real-world physical object). The image data may comprise one or more still images or video. As will be discussed in further detail herein, the sensor(s) 120 can also be used to capture data corresponding to and indicating a current position of the display surface 110. The sensor(s) 120 can also include, but are not limited to, depth sensors, inertial measurement units with accelerometers, gyroscopes, magnometers, and barometers, among other included sensors, and any other type of data capture device embedded within these form factors. The sensor data may be used dynamically, leveraging only the elements and sensors necessary to achieve characterization or classification as befits the use case in question. The sensor data can comprise, visual or image data, audio data, or other forms of data. Other configurations of the sensor(s) 120 are also within the scope of the present disclosure.

In some example embodiments, one or more projectors 125 are configured to project the virtual content on the display surface 110. In some example embodiments, the HMD device 100 is configured to display the virtual content on the display surface 110 in other ways than via a projector 125.

In some embodiments, a virtual content module 150 is stored in memory 130 or implemented as part of the hardware of the processor(s) 140, and is executable by the processor(s) 140. Although not shown, in some embodiments, the virtual content module 150 may reside on a remote server and communicate with the HMD device 100 via a network. The network may be any network that enables communication between or among machines, databases, and devices. Accordingly, the network may be a wired network, a wireless network (e.g., a mobile or cellular network), or any suitable combination thereof. The network may include one or more portions that constitute a private network, a public network (e.g., the Internet), or any suitable combination thereof.

FIG. 2 is a block diagram illustrating components of virtual content module 150, in accordance with some embodiments. In some example embodiments, virtual content module 150 comprises any combination of one or more of a surface position determination module 210, a content location determination module 220, and a display module 230. Other configurations are also within the scope of the present disclosure.

In some embodiments, the surface position determination module 210 is configured to determine whether or not a current position of the display surface 110 of the HMD device 100 satisfies a predetermined condition for displaying virtual content on the display surface. The display surface 110 can be configured to be adjusted between positions that do not satisfy the predetermined condition and positions that do satisfy the predetermined condition. For example, the display surface 110 can be configured to be adjusted to a position corresponding to a display mode in which the virtual content module 150 will enable virtual content to be displayed on the display surface 110, such as by the display surface 110 being rotated down into alignment with the user's eye-line, and the display surface 110 can also be configured to be adjusted to a position corresponding to a non-display mode in which the virtual content module 150 will not enable (e.g., will prevent) virtual content to be displayed on the display surface 110, such as by the display surface 110 being rotated up out of alignment with the user's eye-line.

The surface position determination module 210 can make the determination as to whether or not the current position of the display surface 110 satisfies the predetermined condition in a variety of ways using a variety of mechanisms, including, but not limited to, optical sensors, electrical sensors, and mechanical sensors. For example, the display surface 110 can be configured to lock in place in the display mode via a locking mechanism, and the surface position determination module 210 can be configured to detect when the locking mechanism has been engaged accordingly. In this example, the predetermined condition comprises the display surface 110 being locked into display mode via the locking mechanism. Other configurations for the predetermined condition and other configuration for determining whether or not the current position of the display surface 110 satisfies the predetermined condition are also within the scope of the present disclosure.

As a result of the repeated adjustments in position of the display surface 110, as well as other factors, the precise position of the display surface 110 when in display mode can change over time. These changes in the position of the display surface 110 can cause the virtual content to be displayed in an inappropriate or unintended location on the display surface 110, due to one or more components responsible for determining and implementing the display location of the virtual content failing to compensate for any such change in the position of the display surface 110.

Accordingly, in some example embodiments, the content location determination module 220 is configured to determine display surface position data based on the current position of the display surface 110, and to determine a display location for the virtual content based on the display surface position data. In some example embodiments, the operation of determining the display surface position data is performed in response to the determining that the current position of the display surface satisfies the predetermined condition.

The display surface position data can comprise any data that indicates one or more details of the change in position of the display surface 110. In some example embodiments, the display surface position data can comprise an amount or degree of the change and the direction of the change. In some example embodiments, the display surface position data can comprise data indicating the current position of the display surface 110 based on a detection of a position of a component or element of the display surface 110 or based on a detection of a position of a component or element of configured to move in a corresponding fashion with the display surface 110.

In some example embodiments, the display surface position data comprises coordinates or other position information of the display surface 110 (or of a component of the display surface 110). In some example embodiments, the display surface position data comprises a distance measurement and a direction of the change in the position of the display surface 110, which can then be used to adjust the display location of the virtual content on the display surface 110 consistent with the change in position.

In some example embodiments, the display surface position data is determined using one or more sensors on the HMD device 100 that is/are configured to detect the change in position of a component or element that is coupled to the display surface 110 and that is configured to move in a corresponding fashion with the display surface 110 as the position of the display surface 110 changes. For example, one or more optical sensors can be employed to determine the change in relative position between the frame of the HMD device 100 and a component or element of an adjustable arm used to adjust the position of the display surface 110, where the arm is coupled to the frame of the HMD device 100 at a joint 475. The optical sensor(s) can be disposed on the frame or on the arm or on both.

In some example embodiments, the display surface position data is determined using one or more sensors on the HMD device that is/are configured to detect the change in position of one or more markers disposed on the display surface 110. The marker(s) can be reflective in infrared (IR) space such that a sensor operating in IR emits IR light that can be reflected off of the marker(s) in order to determine their position, and thereby the position of the display surface 110, while the marker(s) remain invisible to the user of the HMD device 100.

In some example embodiments, the content location determination module 220 is configured to use the display surface position data as the display location for the virtual content. In some example embodiments, the content location determination module 220 is configured to use the display surface position data as an offset value in compensating for the change in the position of the display surface 110 since the previous time the display surface 110 was brought into display mode.

In some example embodiments, the recalibration and compensation operations of the present disclosure are performed each time the display surface is detected to have been adjusted to satisfy the predetermined condition of the display mode. In some example embodiments, the display module 230 is configured to display the virtual content at the display location on the display surface 110.

In some example embodiments, the virtual content module 150 is additionally or alternatively configured to determine other environmental factors that affect the display of virtual content on the display surface 110, and to determine the display location for the virtual content based on such factors. Examples of such factors include, but are not limited to, a temperature corresponding to the display surface 110 (e.g., ambient temperature determined by a temperature sensor on the HMD device 100), a humidity level or value corresponding to the display surface 110 (e.g., ambient humidity level or value determined by a humidity sensor).

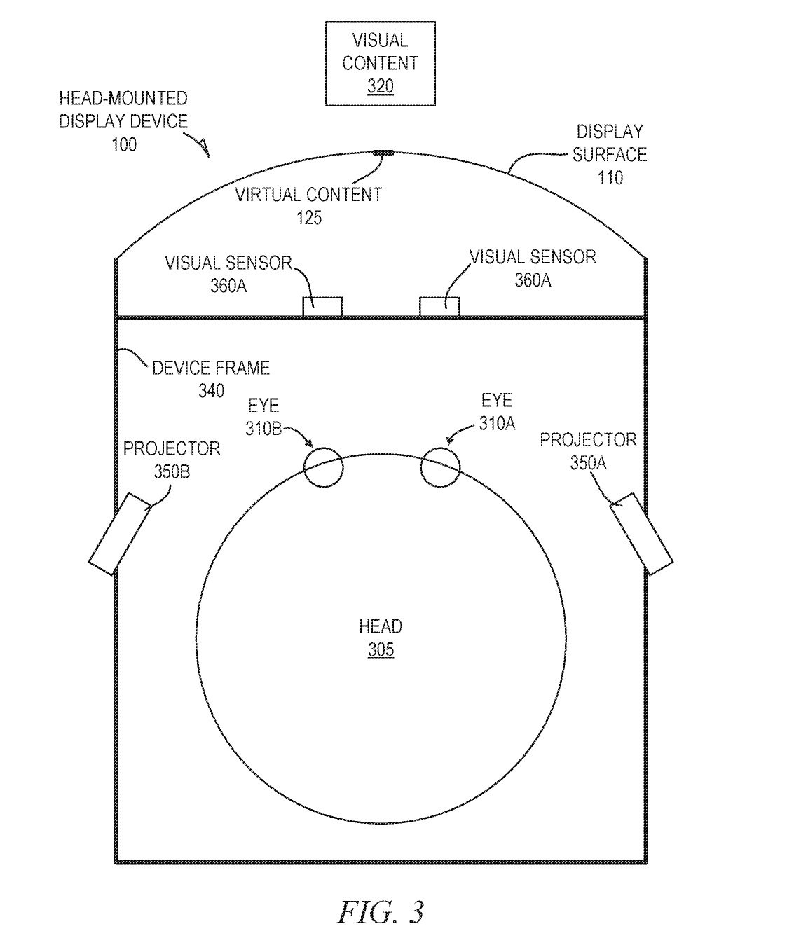

FIG. 3 is a plan view of an HMD device, in accordance with some embodiments. In some embodiments, HMD device 100 comprises a device frame 340 to which its components may be coupled and via which the user can mount, or otherwise secure, the HMD device 100 on the user's head 305. Although device frame 340 is shown in FIG. 3 having a rectangular shape, it is contemplated that other shapes of device frame 340 are also within the scope of the present disclosure. The user's eyes 310a and 310b can look through the display surface 110 of the HMD device 100 at real-world visual content 320. In some embodiments, HMD device 100 comprises one or more sensors, such as visual sensors 360a and 360b (e.g., cameras), for capturing sensor data. The HMD device 100 can comprise other sensors as well, including, but not limited to, depth sensors, inertial measurement units with accelerometers, gyroscopes, magnometers, and barometers, and any other type of data capture device embedded within these form factors. In some embodiments, HMD device 100 also comprises one or more projectors, such as projectors 350a and 350b, configured to display virtual content on the display surface 110. Display surface 110 can be configured to provide optical see-through (transparent) ability. It is contemplated that other types, numbers, and configurations of sensors and projectors can also be employed and are within the scope of the present disclosure.

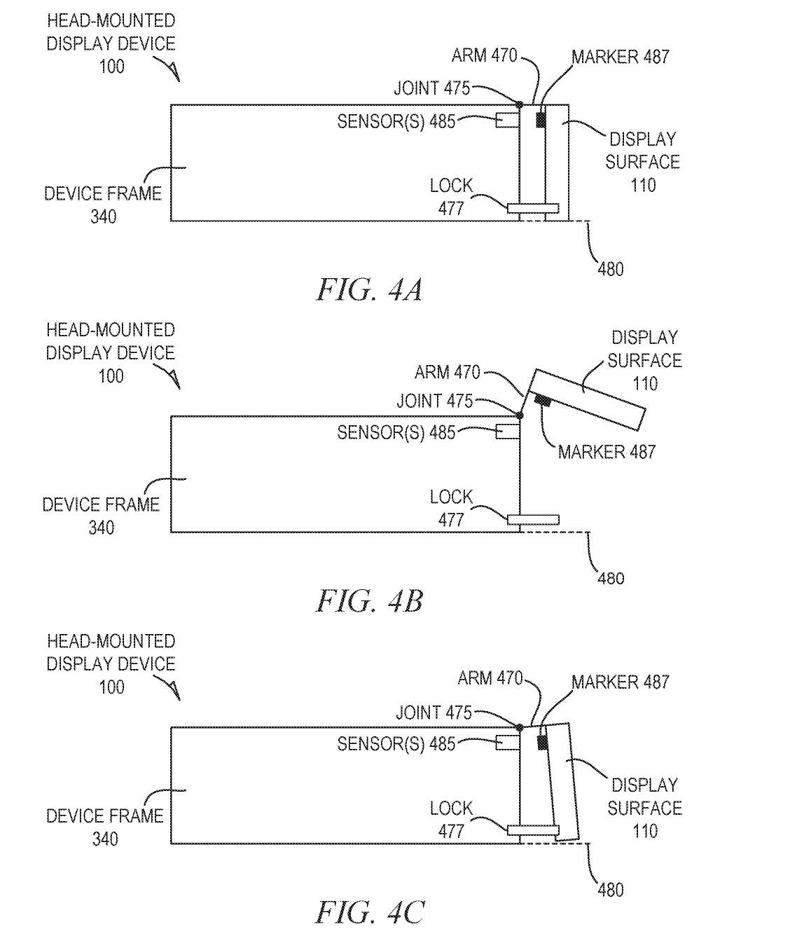

FIGS. 4A-4C illustrates a display surface of an HMD device 100 in different positions, in accordance with some embodiments. In some example embodiments, the HMD device 100 comprises a device frame 340 and a display surface 110 coupled to the device frame 340 in an adjustable configuration via an arm 470. The arm 470 couples the display surface 110 to the device frame 340 at a joint 475, with the relative positioning of the arm 470 with respect to the display surface 110 being fixed, while the relative positioning of the arm 470 with respect to the display surface 110 being variable as the arm 470 rotates with the display surface 110 in a corresponding fashion about the joint 475.

In the example embodiment shown in FIG. 4A, the display surface 110 is in display mode in a first current position at a first time. Dotted line 480 is shown to indicate the first current position (e.g., the position of the bottom surface of the display surface 110). As previously discussed, the surface position determination module 210 can determine whether or not this current first position of the display surface 110 of the HMD device 100 satisfies a predetermined condition for displaying virtual content on the display surface.

In some example embodiments, determining that the current position of the display surface of the head-mounted display device satisfies the predetermined condition comprises determining that the display surface is releasably locked (e.g., the lock can be engaged and disengaged, thereby locking and unlocking) in a display mode position via a locking mechanism 477. The locking mechanism 477 can be coupled to the device frame 340 in a fixed position and can engage the display surface 110 or a component, such as arm 470, coupled to the display surface 110 in a fixed position with respect to the display surface, such that adjustment of the display surface 110 between positions is accompanied by a corresponding adjustment of the component between positions.

In some example embodiments, determining that the current position of the display surface 110 of the head-mounted display device 100 satisfies the predetermined condition comprises detecting that a position marker 487 of the display surface 110 is in a position corresponding to a position that satisfies the predetermined condition, such as the position marker 487 being in alignment with one or more sensors 485 (e.g., an optical sensor that emit IR light to be reflected off of the position marker and detected by the optical sensor to verify that the position marker 487, and thus the display surface 110, is in sufficient position for display of virtual content on the display surface 110). In some example embodiments, the position marker 487 is coupled to the display surface 110 in a fixed position with respect to the display surface 110 (e.g., fixed directly to the display surface or on arm 470), such that adjustment of the display surface 110 between positions is accompanied by a corresponding adjustment of the position marker 487 between positions.

In the example embodiment shown in FIG. 4B, the display surface 110 has been adjusted to be in non-display mode in a second current position at a second time subsequent to the first time of FIG. 4A. Furthermore, the locking mechanism 477 has been disengaged from the display surface 110 to allow the display surface 110 to be adjusted to be in non-display mode in the second current position. In the example embodiment shown in FIG. 4C, the display surface 110 has been adjusted to be in display mode again in a third current position at a third time subsequent to the second time of FIG. 4C, with the locking mechanism 477 engaging the display surface 110 once again. As seen by the position of the display surface 110 with respect to the dotted line 480 in FIG. 4C, although the display surface 110 is once again in display mode, the third current position of the display surface 110 in FIG. 4C is different from the first current position of the display surface 110 in FIG. 4A. As previously discussed, the content location determination module 220 can be configured to determine display surface position data that reflects this change from the first current position in FIG. 4A to the third current position in FIG. 4C, and then use that display surface position data to determine a display location for virtual content on the display surface 110 in FIG. 4C.

In addition to sensor(s) 485 and position marker 487 being used to determine whether or not this current first position of the display surface 110 of the HMD device 100 satisfies a predetermined condition for displaying virtual content on the display surface 110, sensor(s) 485 and position marker 487 can also be used to determine the display surface position data.

Furthermore, sensor(s) 485 can additionally or alternatively comprise one or more environmental sensors configured to determine environmental factors that affect the display of virtual content on the display surface 110, and to determine the display location for the virtual content based on such factors. For example, sensor(s) 485 can comprise a temperature sensor configured to determine a temperature corresponding to the display surface 110 and/or a humidity sensor configured to determine a humidity level or value corresponding to the display surface 110.

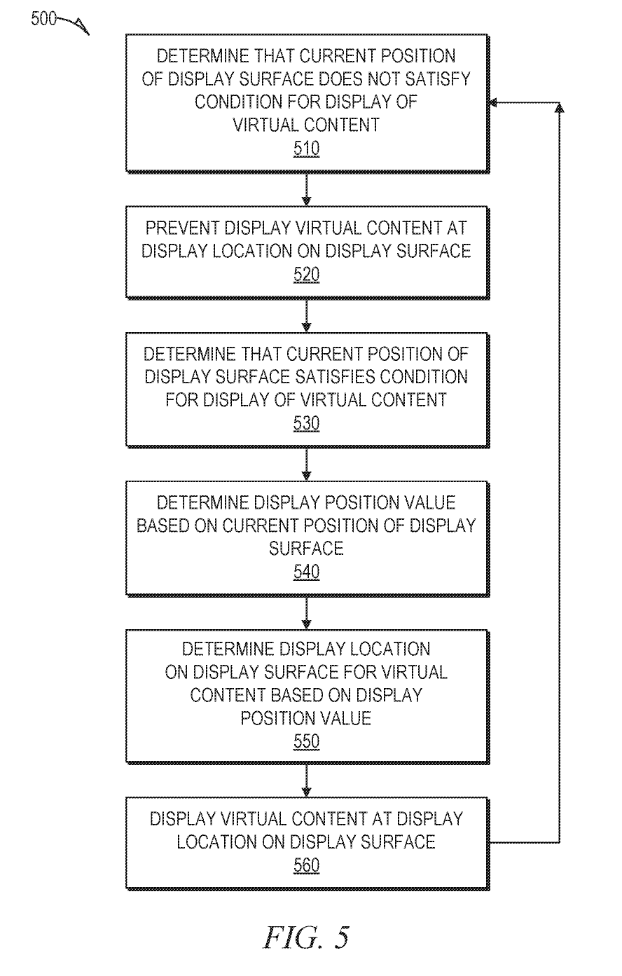

FIG. 5 is a flowchart illustrating a method, in accordance with some embodiments, of correcting a display of virtual content on an HMD device 100. Method 500 can be performed by processing logic that can comprise hardware (e.g., circuitry, dedicated logic, programmable logic, microcode, etc.), software (e.g., instructions run on a processing device), or a combination thereof. In one example embodiment, the method 500 is performed by the virtual content module 150 of FIGS. 1 and 2, or any combination of one or more of its components or modules, as described above.

At operation 510, the virtual content module 150 determines that a current position of a display surface of a head-mounted display device does not satisfy a predetermined condition for displaying virtual content on the display surface, as previously discussed. The display surface is configured to be adjusted between positions that do not satisfy the predetermined condition and positions that do satisfy the predetermined condition, as previously discussed. At operation 520, based on the determination at operation 510, the virtual content module 150 prevents the display of virtual content on the display surface. At operation 530, after the display surface has been adjusted to a new position, the virtual content module 150 determines that a current position of the display surface (different from the current position at operation 510) satisfies the predetermined condition for displaying virtual content on the display surface. At operation 540, the virtual content module 150 determines display surface position data based on the current position of the display surface. In some example embodiments, the operation 540 of determining the display surface position data is performed in response to the determining that the current position of the display surface satisfies the predetermined condition. At operation 550, the virtual content module 530 determines a display location for the virtual content based on the display surface position data. At operation 560, the virtual content module 150 displays the virtual content at the display location on the display surface.

It is contemplated that any of the other features described within the present disclosure can be incorporated into method 500.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 214 of FIG. 2) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

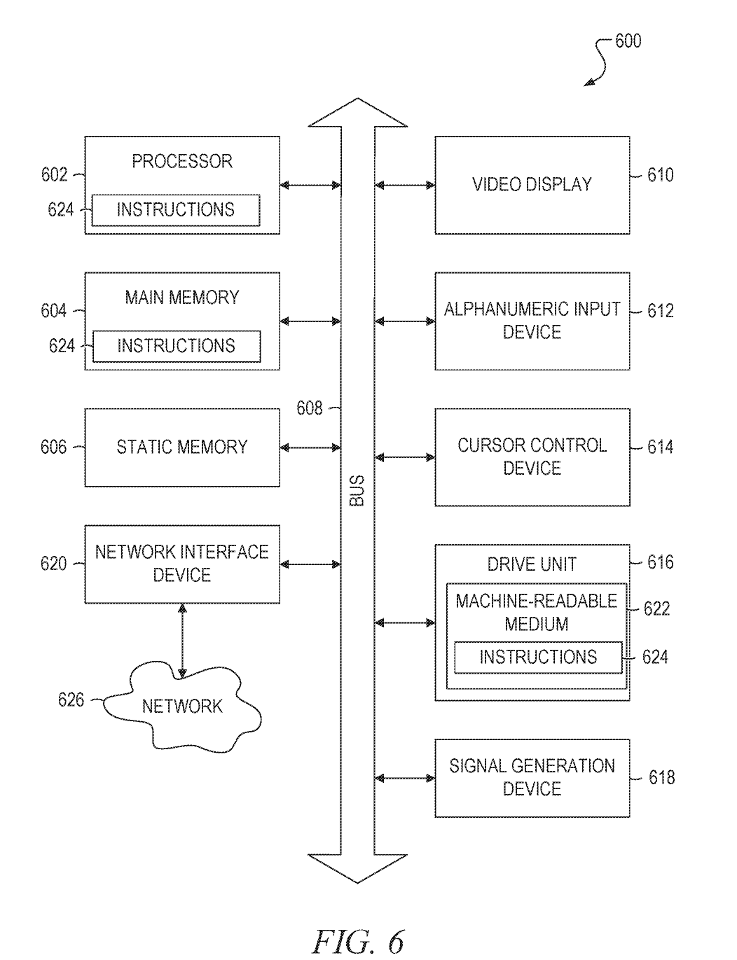

FIG. 6 is a block diagram of a machine in the example form of a computer system 600 within which instructions 624 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a disk drive unit 616, a signal generation device 618 (e.g., a speaker) and a network interface device 620.

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

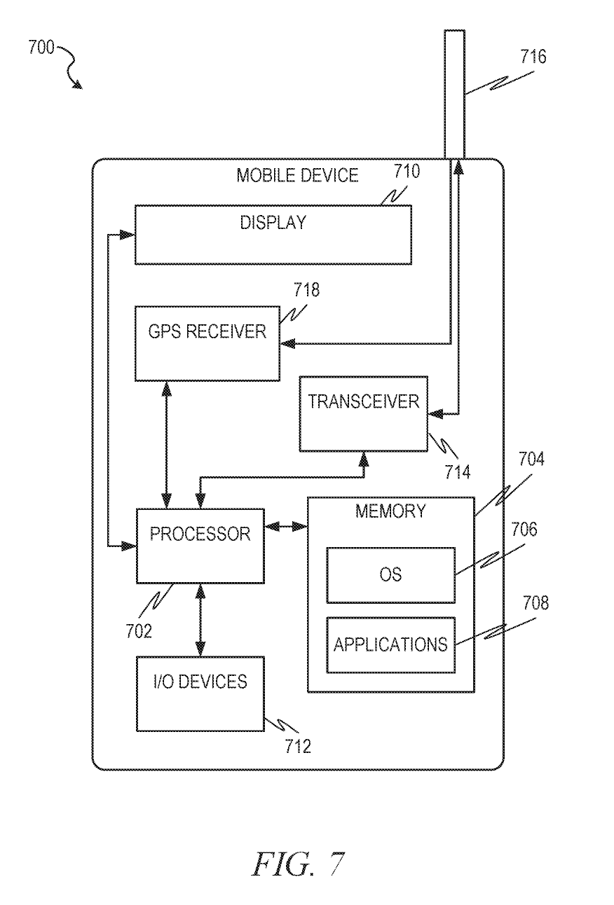

FIG. 7 is a block diagram illustrating a mobile device 700 that may employ the active parallax correction features of the present disclosure, according to an example embodiment. The mobile device 700 may include a processor 702. The processor 702 may be any of a variety of different types of commercially available processors 702 suitable for mobile devices 700 (for example, an XScale architecture microprocessor, a microprocessor without interlocked pipeline stages (MIPS) architecture processor, or another type of processor 702). A memory 704, such as a random access memory (RAM), a flash memory, or other type of memory, is typically accessible to the processor 702. The memory 704 may be adapted to store an operating system (OS) 706, as well as application programs 708, such as a mobile location enabled application. The processor 702 may be coupled, either directly or via appropriate intermediary hardware, to a display 710 and to one or more input/output (I/O) devices 712, such as a keypad, a touch panel sensor, a microphone, and the like. Similarly, in some embodiments, the processor 702 may be coupled to a transceiver 714 that interfaces with an antenna 716. The transceiver 714 may be configured to both transmit and receive cellular network signals, wireless data signals, or other types of signals via the antenna 716, depending on the nature of the mobile device 700. Further, in some configurations, a GPS receiver 718 may also make use of the antenna 716 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment

What is claimed is:

1. A computer-implemented method comprising:
determining that a current position of a display surface of a head-mounted display device satisfies a predetermined condition for displaying virtual content on the display surface, the display surface being configured to be adjusted between positions that do not satisfy the predetermined condition and positions that do satisfy the predetermined condition;
determining display surface position data based on the current position of the display surface;
determining, by a machine having a memory and at least one processor, a display location for the virtual content based on the display surface position data; and
displaying the virtual content at the display location on the display surface.

2. The computer-implemented method of claim 1, wherein the determining the display surface position data comprises determining the display surface position data based on a detection of a position marker using at least one sensor, the position marker being coupled to the display surface in a fixed position with respect to the display surface, and adjustment of the display surface between positions is accompanied by corresponding adjustment of the position marker between positions.

3. The computer-implemented method of claim 1, wherein the determining the display location for the virtual content based on the display surface position data comprises using the display surface position data as an offset value to apply to a previously-determined display location on the display surface in compensating for a change in position of the display surface since a display of previous virtual content on the display surface at a previous time.

4. The computer-implemented method of claim 1, wherein the determining the display location for the virtual content is further based on at least one of an ambient temperature of the display surface and an ambient humidity level of the display surface.

5. The method of claim 1, wherein the determining the display surface position data is performed in response to the determining that the current position of the display surface satisfies the predetermined condition.

6. The computer-implemented method of claim 1, wherein determining that the current position of the display surface of the head-mounted display device satisfies the predetermined condition comprises determining that the display surface is releasably locked in a display mode position via a locking mechanism.

7. The computer-implemented method of claim 1, wherein determining that the current position of the display surface of the head-mounted display device satisfies the predetermined condition comprises detecting that a position marker of the display surface is in a position corresponding to the current position of the display surface satisfying the predetermined condition, the position marker being coupled to the display surface in a fixed position with respect to the display surface, and adjustment of the display surface between positions is accompanied by corresponding adjustment of the position marker between positions.

8. A system comprising:
a machine having a memory and at least one processor; and
at least one module, executable on the at least one processor, configured to perform operations comprising:
determining that a current position of a display surface of a head-mounted display device satisfies a predetermined condition for displaying virtual content on the display surface, the display surface being configured to be adjusted between positions that do not satisfy the predetermined condition and positions that do satisfy the predetermined condition;
determining display surface position data based on the current position of the display surface;
determining a display location for the virtual content based on the display surface position data; and
displaying the virtual content at the display location on the display surface.

9. The system of claim 8, wherein the determining the display surface position data comprises determining the display surface position data based on a detection of a position marker using at least one sensor, the position marker being coupled to the display surface in a fixed position with respect to the display surface, and adjustment of the display surface between positions is accompanied by corresponding adjustment of the position marker between positions.

10. The system of claim 8, wherein the determining the display location for the virtual content based on the display surface position data comprises using the display surface position data as an offset value to apply to a previously-determined display location on the display surface in compensating for a change in position of the display surface since a display of previous virtual content on the display surface at a previous time.

11. The system of claim 8, wherein the determining the display location for the virtual content is further based on at least one of an ambient temperature of the display surface and an ambient humidity level of the display surface.

12. The system of claim 8, wherein the determining the display surface position data is performed in response to the determining that the current position of the display surface satisfies the predetermined condition.

13. The system of claim 8, wherein determining that the current position of the display surface of the head-mounted display device satisfies the predetermined condition comprises determining that the display surface is releasably locked in a display mode position via a locking mechanism.

14. The system of claim 8, wherein determining that the current position of the display surface of the head-mounted display device satisfies the predetermined condition comprises detecting that a position marker of the display surface is in a position corresponding to the current position of the display surface satisfying the predetermined condition, the position marker being coupled to the display surface in a fixed position with respect to the display surface, and adjustment of the display surface between positions is accompanied by corresponding adjustment of the position marker between positions.

15. A non-transitory machine-readable storage medium, tangibly embodying a set of instructions that, when executed by at least one processor, causes the at least one processor to perform operations comprising:
determining that a current position of a display surface of a head-mounted display device satisfies a predetermined condition for displaying virtual content on the display surface, the display surface being configured to be adjusted between positions that do not satisfy the predetermined condition and positions that do satisfy the predetermined condition;
determining display surface position data based on the current position of the display surface;
determining a display location for the virtual content based on the display surface position data; and
displaying the virtual content at the display location on the display surface.

16. The non-transitory machine-readable storage medium of claim 15, wherein the determining the display surface position data comprises determining the display surface position data based on a detection of a position marker using at least one sensor, the position marker being coupled to the display surface in a fixed position with respect to the display surface, and adjustment of the display surface between positions is accompanied by corresponding adjustment of the position marker between positions.

17. The non-transitory machine-readable storage medium of claim 15, wherein the determining the display location for the virtual content based on the display surface position data comprises using the display surface position data as an offset value to apply to a previously-determined display location on the display surface in compensating for a change in position of the display surface since a display of previous virtual content on the display surface at a previous time.

18. The non-transitory machine-readable storage medium of claim 15, wherein the determining the display location for the virtual content is further based on at least one of an ambient temperature of the display surface and an ambient humidity level of the display surface.

19. The non-transitory machine-readable storage medium of claim 15, wherein the determining the display surface position data is performed in response to the determining that the current position of the display surface satisfies the predetermined condition.

20. The non-transitory machine-readable storage medium of claim 15, wherein determining that the current position of the display surface of the head-mounted display device satisfies the predetermined condition comprises determining that the display surface is releasably locked in a display mode position via a locking mechanism.
